(19) United States
(12) Patent Application Publication
(10) Pub. No.: US 2007/0168467 A1
(43) Pub. Date: Jul. 19, 2007

(54) Method and system for providing remote access to baggage scanned images

(75) Inventors: Hui Hu, Plymouth, MN (US); Douglas Boyd, Hillsborough, CA (US)

Correspondence Address: IPCI CONSULTANTS, ONE MOSLEY ACRES, ST. LOUIS, MO, 63141, US

(73) Assignee: TeleSecurity Sciences Inc.

(21) Appl. No.: 11/331,558

(22) Filed: Jan. 15, 2006

(51) Int. Cl. G06F 15/16

(52) U.S. Cl. 709/219

(57) ABSTRACT

A remote access security network is provided that comprises a local terminal receiving scan data representative of objects scanned during a security check. An enterprise server communicates with the local terminal. The enterprise server processes the scan data to form a displayable image and provides remote access to the displayable image upon request. A remote terminal located remote from the enterprise server and remote from the local terminal communicates with the enterprise server over a high-speed connection to provide remote review of the displayable image at the remote terminal associated with the scan data obtained at the local terminal. The enterprise server may include a passenger information interface configured to access a passenger information database having passenger information. The enterprise server may include a conferencing module for establishing a video conference between multiple remote terminals to permit operators of the multiple remote terminals to view simultaneously an individual, common scan image. The local terminal may include an instant-messaging module that, upon a command from a local operator, generates a review request that the enterprise server automatically routes from the local terminal to the remote terminal. The enterprise server may include an electronic unpacking module that, upon request from one of the local and remote terminal, removes portions of the scan image to expose interior items within the scan data.

### BACKGROUND OF THE INVENTION

Certain embodiments generally relate to methods and systems for providing remote access to baggage scanned images and passenger security information.

In recent years there has been increasing interest in the use of imaging devices at airports to improve security. The President signed the Aviation and Transportation Security Act on Nov. 19, 2001, which, among other things, mandated that all luggage checked for international travel should be inspected by a explosives detection system (EDS). The Federal Aviation Administration (FAA), now the Transportation Safety Administration (TSA) a division of Homeland Security Administration (HAS) has sets standards for qualifying explosives detection systems. To date all certified systems have represented computed tomography (CT) scanners and in one instance, a diffraction imaging (DI) scanners. Today thousands of CT scanners are installed at airports to scan checked baggage. The CT and DI scanners generate images representative of cross-sections of each scanned bag. The images are processes by an automated image recognition system, such as for certain patterns, characteristics and the like. When the image recognition system identifies a potential threat, the images are brought to the attention of an operator. The scanners are operated by TSA personnel who view cross sectional images of the baggage that is identified by the automated detection software to be a possible threat.

Scanners are capable of producing fully 3-dimensional images by stacking a series of closely spaced cross section images into a 3D matrix. The 3D image may then be viewed by an operator. However, the software required to view such 3D images is complex and generally requires sophisticated operators with expertise in 3D rendering software tools. However, the shape and position of potential explosive devices may vary and sometimes threat resolution may require a detailed knowledge of the chemical properties of explosives and the physics of packaging. Given the number of scanners throughout the United States, it is difficult (if not impossible) to staff each scanner with an operator have the expert skills preferred to accurately and reliably analyze potential threats or items of interest. Hence, a particular circumstance may be beyond the skills and capability of certain scanner operators.

Further, the demands placed on scanner operators are further exaggerated by the time pressures of the application. The time pressures result from the need to examine baggage between the time that the baggage is checked and loaded on a flight. Often travelers check-in only shortly before their scheduled departure time, thereby permitting little time for the scanner operator to view the baggage.

There is a need for an improved airport EDS system that meets the above noted problems and other problems experienced in the EDS field. It is a goal of certain embodiments to meet such needs.

### BRIEF DESCRIPTION OF THE INVENTION

In accordance with certain embodiments, a remote access security network and method of operating the same are provided. The network comprises a local terminal receiving scan data representative of objects scanned during a security check and an enterprise server that communicates with the local terminal. The enterprise server processes the scan data to form a displayable image and provides remote access to the displayable image upon request. A remote terminal located remote from the enterprise server and remote from the local terminal communicates with the enterprise server over a network connection to provide remote review of the displayable image at the remote terminal associated with the scan data obtained at the local terminal or by the enterprise server.

In accordance with certain embodiments, the enterprise server may include a passenger information interface configured to access a passenger information database having passenger information. In accordance with certain embodiments, the enterprise server may include a conferencing module for establishing a video conference between multiple remote terminals to permit operators of the multiple remote terminals to view simultaneously an individual, common scan image. In accordance with certain embodiments, the local terminal may include an instant-messaging module that, upon a command from a local operator, generates a review request that the enterprise server automatically routes from the local terminal to the remote terminal. In accordance with certain embodiments, the enterprise server may include an electronic unpacking module that, upon request from one of the local or remote terminal, removes portions of the scan image to expose interior items within the scan data.

In accordance with certain embodiments, systems and methods are provided to over-read images on a time-critical basis. The systems and methods enable decisions to be made within minutes of scanning an item, thereby rendering scan images available to remote experts on a near real-time basis. In accordance with certain embodiments, systems and methods are provided that enable experts to use sophisticated internet based software tools to examine the objects inside a checked bag in three-dimension, as well as examine the interior of such objects, namely electronic unpacking. In accordance with certain embodiments, systems and methods are provided that afford online storage of scan images for at least the duration of a typical event (e.g. domestic or international flight, concert, multi-day convention, office hours of a secure building and the like), in order that subsequent scan images may be compared with scan images obtained earlier in the event.

In accordance with certain embodiments, systems and methods are provided to access and interrogate airline passenger information system databases so that the expert may view the passenger's information (e.g., flight itinerary, and possibly previous travel history). In accordance with certain embodiments, systems and methods are provided to collaborative train airport operators through conferencing together multiple remote users and one or more experts. The operators may collaborate on the analysis of sample items under the guidance of the remote expert. In accordance with certain embodiments, systems and methods are provided to monitor the quality of electronic data scanning (EDS) devices and their operators by providing access to the real-time images to off-site experts.

### BRIEF DESCRIPTION OF THE DRAWINGS

FIG. 1 illustrates a general block diagram of a remote access security network formed in accordance with an embodiment.

FIG. 2 illustrates a detailed block diagram of a portion of the remote access security network of FIG. 1.

FIG. 3 illustrating a flow chart for an exemplary sequence of operations carried out by the enterprise server to receive and respond to a scan image request from a remote terminal.

FIG. 4 illustrating a flow chart for an exemplary sequence of operations carried out by the enterprise server to establish and maintain a remote conference.

### DETAILED DESCRIPTION OF THE INVENTION

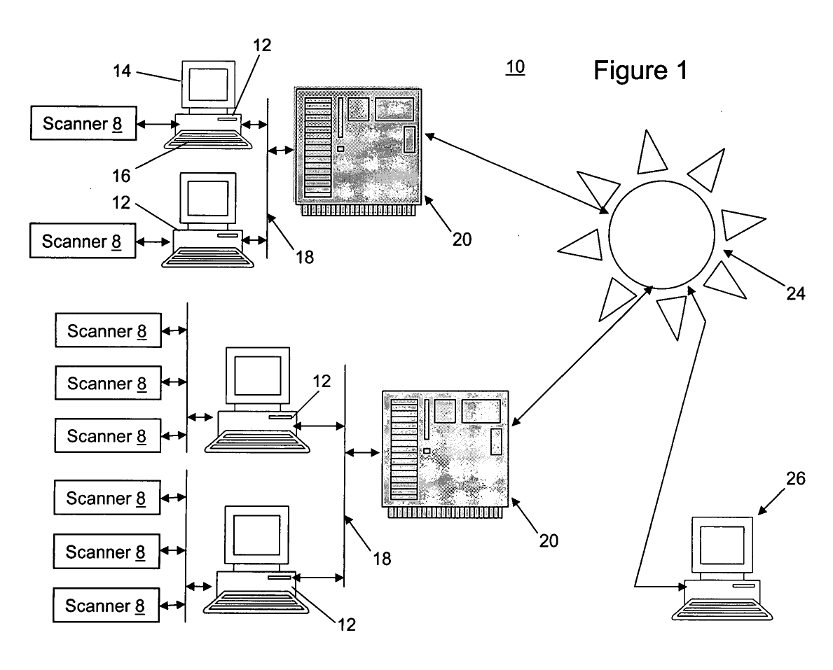

FIG. 1 illustrates a block diagram of a remote access security network 10 that is formed in accordance with an embodiment. The network 10 is joined to multiple image capture or scanner devices 8 (e.g., a CT scanner, a DI scanner, an X-ray scanner and the like). Each scanner device 8 is located in an area under restricted access, such as i) an airport terminal or concourse where passengers enter and leave, ii) a non-public airport area where checked baggage is conveyed to airport employees for loading on airplanes. Other examples of areas under restricted access are office buildings, government buildings, court buildings, museums, monuments, sporting events, stadiums, concerts, convention centers and the like.

Each scanner device 8 includes a scanner source and detector to directly scan each item of interest, a controller module to control operation of the scanner device, a user interface to afford operator control, and a monitor to display images obtained by the scanner. The scanner device 8 communicates bi-directionally with a local terminal/server 12 that is configured to, among other things, operate as a local server. The scanning device 8 scans objects of interest, such as baggage (e.g. luggage, backpacks, briefcases, purses, and the like). The scanning device 8 obtains and conveys each image of a piece of baggage to the local terminal 12. The local terminal 12 captures each scan image as produced in real-time and stores the scan images in local memory, such as on the hard drive of the local terminal 12. The local terminal 12 includes a monitor 14 to display the scan images in real-time as a object is passing through the scanner device 8. The local terminal 12 also includes a user interface 16 to provide an operator control over the local terminal 12 and scanner device 8. Optionally, a single local terminal 12 may be connected to one or more nearby scanner devices 8 that are located in close proximity to one another, so that each operator can have access to the console of the local terminal 12.

The scanner device 8 includes software that controls the operation thereon. The scanner device 8 may scan only a single slice, or selected slices of objects of interest (e.g., dense objects). Alternatively, the scanner device 8 may scan adjacent, successive slices of the object of interest. The scanner device 8 may generate one or multiple images of each bag being scanned. Optionally, the scanner device 8 may include a scan converter that performs scan conversion upon the scan images before passing the images to the local terminal 12. Optionally, the local monitor 12 may have a video output port, from which still and video images displayed at monitors 135 are captured and transferred to the enterprise server 150.

The scan images (defined by scan data) are sent from the local terminal 12 over a private communications link, such as a local area network (LAN), to an enterprise server 20. The transfer of scan images may be initiated independently by the local terminal 12 or under the command of the enterprise server 20. The scan images are conveyed to the enterprise server 20 substantially in real-time. The term “real-time” as used through out shall include the time period while the object being scanned is still within the scanner device, and shall also include a period of time immediately after the object exits the scanning device 8 while the object is still within the restricted access area. For example, “real-time” would include the time from when a bag is checked up, the time in which the bag is transported to the flight, the time in flight, and the time in which the bag is transported from the flight to the bag retrieval area at the destination airport. In the example of a government building, “real-time” would include the time from when the object first enters the building until the object is carried out of the building. In the example of a live event, “real-time” would include the time from when the object enters the event area (e.g., fair ground, stadium, etc.) up until the object leaves the event area.

Optionally, the local terminal 12 may add, to the scan data, ancillary scan/object related information. For example, ancillary scan related information may include the time at which the scan took place. Ancillary object information may include a unique bag identifier. For example, bar code readers may be provided along the conveyers to automatically detect bar codes provided on the tags added to luggage (checked or carry on). The bar code would include, among other things, a unique bag identifier that could then be added to the scan data once the bag has passed through the scanner device 12. In the foregoing example, the bar code reader is automated. Alternatively, the bar codes may be scanned manually, such as with a hand held bar code or a bag ID may be manually entered by an operator as the bag passes through the scanner device 12.

In the example of FIG. 1, more than one enterprise server (ES) 20 is shown, and each enterprise server 20 is connected to multiple local terminals 12. For example, one enterprise server 20 may be provided for each restricted access area (e.g., one ES per airport terminal, one ES per airport concourse, one ES per museum, one ES per government building). Alternatively, one enterprise server 20 may be service multiple restricted access areas, depending upon the geographic proximity of the restricted access areas and the form of communications link maintained between the local terminals 12 and the enterprise server 20.

The scan images are conveyed from the local terminals 12 to the ES 20 in one of several image formats (e.g., TIFF, JPEG, PDF, etc.). Each image file is assigned a header that identifies which scanner device 8 produced the image, the time of the scan, the passenger ID, and other data obtained at the point of scan. The image files are stored for 48 hours or more depending on the needs of the restricted access area.

The enterprise server 20 is connected, through a network connection 24 (e.g., the internet, a private network, etc.), to multiple remote terminals 26 that may be used by experts in a manner explained hereafter. The enterprise server 20, performs numerous operations, such as responding to inquiries for specific scan images. The inquires may come from a remote terminal 26 over the high-speed connection 24 or from a local terminal 12 over the LAN 18. The enterprise server 20 obtains the requested scan image(s) from memory, compresses and encrypts the scan image(s) and sends the compressed scan image(s) in a compressed, encrypted manner to the requesting remote terminal 26 or local terminal 12. The compressed scan image(s) is conveyed with a standard internet transport protocols. By way of example, an enterprise server may service all of the local terminals 12 in a single large airport terminal building, or the entire airport for medium-size, and smaller airports. A larger airport such as LAX or JFK may have several enterprise servers 20, corresponding to the different terminal buildings.

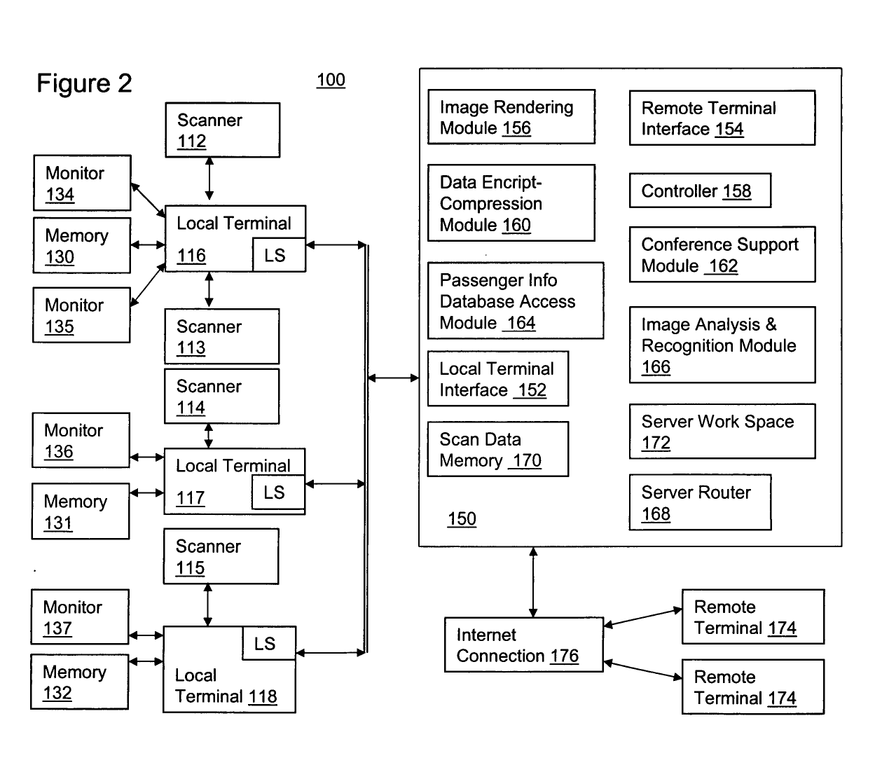

FIG. 2 illustrates a detailed block diagram of a remote access security network 100 that includes multiple scanners 112-115 for scanning objects of interest as the objects pass into a restricted access area. One ore more of scanners 112-115 are joined to individual or common local terminals 116-118. Optionally, a series of scanners may be joined in a daisy chain or other serial manner (e.g., scanner #1 is connected to scanner #2 which is connected to scanner #3) with one an end scanner (e.g. scanner #1 or #3) being directly joined to the local terminal. Scan data is passed from the scanners 112-115 to the corresponding local terminals 116-118. For example, the scan data may represent projection image data sets obtained from a CT scanner having an x-ray source and detector that rotate about the object. Alternatively, the scan data may represent a collection of line scans of an object obtained by a line scanner, wherein the line scans are joined to form a data set representing a single 2D data pattern of attenuation measurements.

Each local terminal 116-118 includes a user interface (not shown), is joined to local memory 130-132, and displays images and other information on a local monitor 134-137. The user interfaces permit operators to control operation of the scanners 112-115, scan images from which are shown on the local monitors 134-137 and stored in local memory 130-132. Each local terminal 116-118 includes or is joined to local servers 122-124 that bi-directionally interconnect the local terminals 116-118, over a local area network 140, to an enterprise server 150.

The enterprise server 150 receives scan data from the local terminals 116-118, and stores the scan data in memory 170. The enterprise server 150 processes the scan data, as explained below, and conveys display images to remote terminals 174 over a high-speed connection 176 such as the internet. The local and remote terminals 114-116 and 174 may represent personal computers running conventional internet browsers, personal digital assistants (PDAs) having web browser access and capability, cell phones, laptop computers, imaging workstations and the like.

The enterprise server 150 includes sophisticated 3D rendering tools that respond to commands from the remote user and may serve processed 3D images, including MIP and volume rendered images. For example, an expert at a remote terminal 174 may call for a particular set of images by addressing a particular IP address through an internet browser. The IP address may be associated with a local scanner. The browser may be running on a local computer system that constitutes a remote terminal 174 (e.g., a PC of any type, or a handheld computer, and even in certain cases a cell phone). The expert at the remote terminal 174 may be alerted by the enterprise server 150 of a problem set of images via an instant message sent from the user interface of the local terminal 116 at local airport imaging device by the operator. Optionally, an instant message alert command may be sent to multiple experts (e.g., multiple remote terminals 174) at diverse locations, simultaneously. Sending the instant message to multiple remote terminals 174 increases the probability of immediate response from one or more experts.

The enterprise server 150 includes a local terminal interface 152 and a remote terminal interface 154 for validating and verifying the local and remote terminals 116-118 and 174, respectively. A controller 158 controls overall operation of the enterprise server 150. An image rendering module 156 performs various operations upon the scan data to convert the scan data to displayable images viewable by operators of the remote terminals 174. For example, the image rendering module 156 may perform volume rendering, reconstruction, image fusion, image animation and the like. The image rendering module 156 operates based on requested information received from a remote terminal 174, such as a presentation mode, mode settings, and the like. By way of example only, the image rendering module 156 may access scan data memory 170 to obtain requested scan data associated with a single scan, a set of scans and the like. The image rendering module 156 operates upon the requested scan data and generates one or more displayable images and/or one or more groups of displayable images (such as forming a video clip when looped through). The displayable images are stored in a server workspace 172. Optionally, the scan data may be directly obtained from the local terminal 116-118 and/or local memory 130-132. The server workspace 172 is dynamically configurable under the control of the controller 158 and/or server/router 168 to allocate space in the server workspace 172 for each request received from a remote terminal 174.

For example, a first remote terminal 174 may request a set of three images (e.g., top, side and end views) of an object scanned in scanner #1, while a second remote terminal 174 may request a three-dimensional surface rendered image of an object scanned in scanner #2. Local terminal 116 may send out an instant message to remote terminals 174 located in the same time zone as the local terminal 116 to view a short cine/video clip of an object being turned 180 degrees about a vertical axis. In each of the foregoing requests, the controller 158 accesses the corresponding scan data and passes the scan data to the image rendering module 156, along with the presentation mode, settings and other necessary information. The controller 158 may, upon receiving each request, allocate a separate workspace section to the request (e.g. such as designated by an IP address). The image rendering module 156 processes each set of scan data in the appropriate manner and passes the resulting displayable image(s) to the server workspace 172 for temporary storage. Once the requested displayable image(s) are complete, the controller 158 may transmit the displayable image(s) to the designated remote terminal(s) 174. Alternatively, the controller 158 may inform the remote terminal 174 that the displayable image(s) are stored and available at a designated IP address at server workspace 172. The remote terminal 174 may then download, or access for direct viewing, the displayable images from the server workspace 172 through the server 168.

Optionally, the scan data memory 170 may also record actions of an operator of one of local and remote terminals to form an action recording. The enterprise server 150 then replays the action recording in connection with training and/or quality control.

The enterprise server 150 also includes a data encryption compression module 160 that may be utilized to compress and/or encrypt the displayable images once generated by the image rendering module 156. The amount and type of compression and encryption may be based on default settings for the system or for the requesting local or remote terminal 116-118 and 174. Alternatively, the requesting local or remote terminal 116-118 and 174 may include with the request the amount and type of compression and encryption.

A conference support module 162 is provided to support conferences of multiple local and remote users who may simultaneously view and interact with the same displayable image set. When the controller 158 receives a remote inquiry for a particular image set, the controller 158 activates the conference support module 162 to establish, maintain and manage audio and video content of the conference. The enterprise server 150 includes a conferencing module for establishing a video conference between multiple remote terminals 174 to permit operators of the multiple remote terminals to view simultaneously an individual, common scan image.

The controller 158 will also simultaneously have the ability to query the passenger information database access module 164 to access the airline passenger information database and provide information about the passenger. The passenger information may include at least one of a passenger itinerary, travel history, credit information, profile, passport information, passenger photograph, family history, and job information. The passenger information may be helpful to an expert who is analyzing the probability that a given image represents a threat. The enterprise server associates the scan data with passenger information for a corresponding passenger checking in the scanned item.

An image analysis and recognition module 166 may be utilized to analyze the scan data in memory 170 and/or the displayable images in server workspace 172. The image analysis and recognition module 166 performs pattern recognition analysis to identify potential threats. For example, pattern recognition analysis may perform computer aided detection of the scan data in connection with identifying potential objects of interest. Optionally, when a potential threat is identified, the image analysis and recognition module 166 may add marker indicia to the displayable image (e.g., highlight an area, circle an area, add an arrow pointing to the area and the like). As a further example, the potential threat may be outlined in color and a request transmitted to request expert review.

The server/router 168 provides an internet based interface over the high-speed connection 176 with the remote terminals 174. 14.

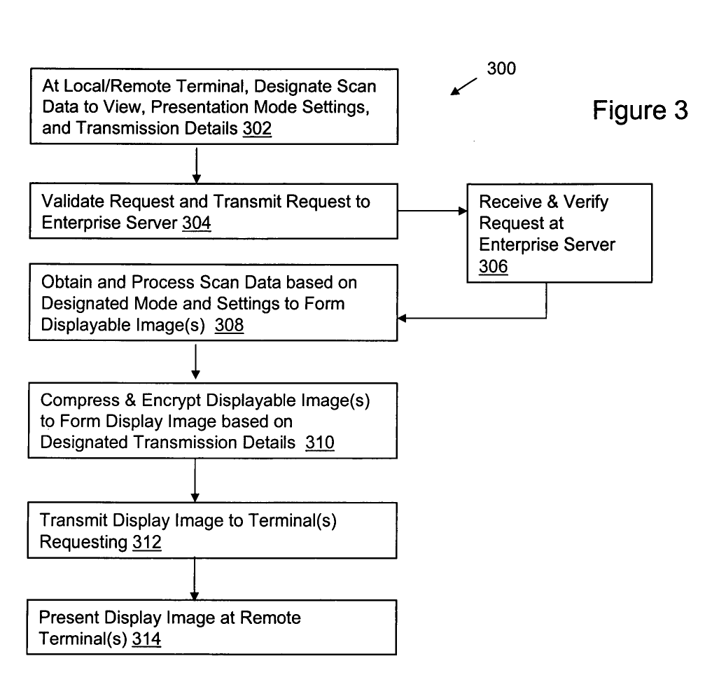

FIG. 3 illustrates an exemplary processing sequence carried out (at least in part) by the image rendering module 156 in connection with generation of a displayable image. The image presentation process 300 includes, designating at 302, the scan data to view, the presentation mode, the mode settings, the transmission details and the like. The designation at 302 may originate at a local or remote terminal or at the enterprise server. For example, the scan data may be designated by identifying a scanner ID, a particular time of day, real-time, a passenger ID, a flight number, an airline, and the like. The scan data may also be designated based on the nature and other characteristics of the object (e.g., show any objects being scanned in real-time that have a select shape, attenuation measurement profile, and the like).

At 304, the request is validated (e.g., by the requesting local or remote terminal 116-118-174 or by the enterprise server 150). Also at 304, once the request is validated the request is transmitted to the enterprise server 150. The validation may include confirming that the entered information is accurate, that the operator has approval to view the requested information and the like. At 306, the request is received and verified at the enterprise server 150. At 308, the scan data is obtained (such as from a local terminal 116-118 or from scan data memory 170) and processed by the image rendering module 156 based on the designated mode and settings. At 310, the data encryption and compression module 160 encrypts and compresses the displayable images based on the designated transmission details. At 312, the enterprise server 150 transmits displayable image(s) to the requesting local and remote terminals 116-118 and 174. The requesting local and remote terminals 116-118 and 174 present the displayable images.

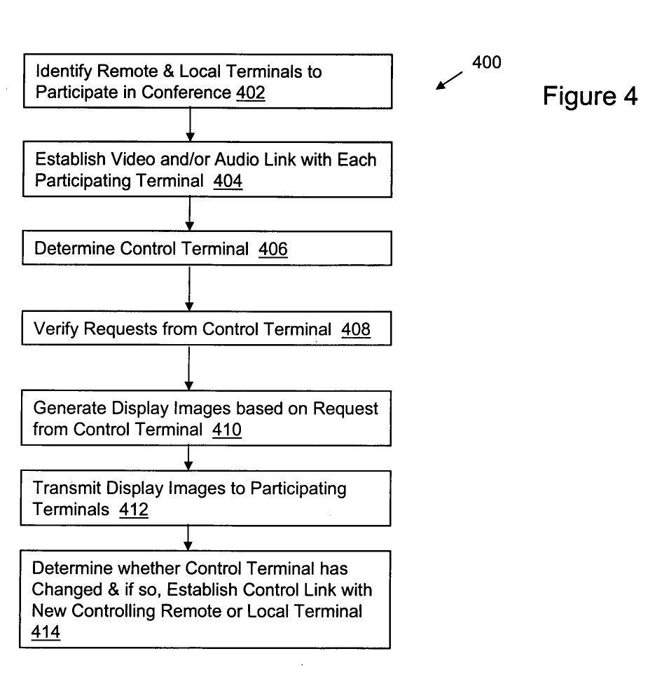

FIG. 4 illustrates a processing sequence to conduct a conference with multiple local and remote terminals 116-118 and 174. The conference process 400 begins by identifying at 402 each local and remote terminal 116-118 and 174 that will participate. The participating local and remote terminals 116-118 and 174 may be based on individual requests or predefined. At 404, a video and/or audio link is established with each participating terminal. At 406, the conference support module 162 determines which terminal will at least initially control the images to be displayed. At 408, the controller 158 verifies a request for scan data from the controlling terminal. At 410, the image rendering module 156 generates the displayable images based on the request from the controlling terminal (local or remote). At 412, the displayable image(s) is transmitted to the participating terminals (local and remote). At 414, the conference support module 162 determines whether a requested has been made for the control terminal to change. If a control change request has occurred, the conference support module 162 establishes a control link with the local or remote terminal designated to become the control terminal.

In the above examples, the scanners are described in connection with CT and DI scanners and the data sets are described in connection with attenuation measurement data. However, alternatively other types of scanners and other types of data may be obtained, processed and displayed without departing from the meets and bounds of the present invention. For example, the scanner may represent an electron beam scanner. Alternatively, the scanner may transmit and receive non-x-ray forms of energy, such as electromagnetic waves, microwaves ultraviolet waves, ultrasound waves, radio frequency waves and the like. Similarly, in the above described embodiments, the scan data is representative of attenuation measurements taken at various detector positions and projection angles, while the object is stationary within the scanner or while the object is continuously moving through the scanner (e.g., helical or spiral scanning). Alternatively, when non-x-ray forms of energy are used, the scan data may represent non-attenuation characteristics of the object. For example, the data may represent an energy response or signature associated with the object and/or the content of the object, wherein different types of objects may exhibit unique energy responses or signatures. For example, explosives, biological agents, and other potentially threatening medium, may exhibit unique electromagnetic responses when exposed to certain fields, waves, pulse sequences and the like. The electromagnetic response of the object and the content of the object is recorded by the scanner as scan data. As a further example, the scanner may be used to obtain finger prints from the object. The finger prints would be recorded as scan data.

The modules discussed above in connection with various embodiments are illustrated conceptually as a collection of modules, but may be implemented utilizing any combination of dedicated hardware boards, DSPs and processors. Alternatively, the modules may be implemented utilizing an off-the-shelf PC with a single processor or multiple processors, with the functional operations distributed between the processors. As a further option, the modules may be implemented utilizing a hybrid configuration in which certain modular functions are performed utilizing dedicated hardware, while the remaining modular functions are performed utilizing an off-the shelf PC and the like.

It is understood that the above exemplary embodiments may be used in connection with checked bags, as well as carry-on luggage.

While the invention has been described in terms of various specific embodiments, those skilled in the art will recognize that the invention can be practiced with modification within the spirit and scope of the claims.

What is claimed is:

1. A remote access security network, comprising:
a local terminal receiving scan data representative of objects scanned during a security check;
an enterprise server communicating with the local terminal, the enterprise server retrieving or processing the scan data to form a displayable image and providing remote access to the displayable image upon request; and
a remote terminal located remote from the enterprise server and remote from the local terminal, the remote terminal communicating with the enterprise server over a network connection to provide remote review of the displayable image at the remote terminal associated with the scan data obtained at the local terminal.

2. The network of claim 1, wherein the local terminal and the enterprise server are joined via a local area network.

3. The network of claim 1, wherein the enterprise server and the remote terminal communicate with one another over the internet.

4. The network of claim 1, wherein the enterprise server transmits the displayable image to the remote terminal in a compressed, encrypted formal.

5. The network of claim 1, further comprising multiple local terminals that are all located at a single airport and are joined to a single enterprise server, the single enterprise server controlling access to the scan data from all of the multiple local terminals.

6. The network of claim 1, further comprising multiple local terminals that are all located at a single airport and multiple remote terminals located remote from the single airport.

7. The network of claim 1, wherein the enterprise server responds to inquires from the remote terminal for specific the displayable images.

8. The network of claim 1, wherein the enterprise server includes a 3D rendering module that generates a 3D image based on a set of the scan data associated with a scanned item, the enterprise server allowing the remote terminal access to the 3D image.

9. The network of claim 1, wherein the enterprise server includes a 3D rendering module that generates a 3D image based on a set of the scan data associated with a scanned item, the 3D image representing one of a surface rendering and a volume rendering.

10. The network of claim 1, wherein the enterprise server, upon receiving an inquiry for a set of the scan data, collects and formats the set of scan data, and transmits the set of scan data to the remote terminal.

11. The network of claim 1, wherein the local terminal is provided immediately proximate one of a CT and DI scanner, and the remote terminal is provided remote from the one of a CT and DI scanner.

12. The network of claim 1, wherein the enterprise server includes a passenger information interface configured to access a passenger information database having passenger information, the passenger information including at least one of a passenger itinerary, travel history, credit information, profile, passport information, passenger photograph, family history, and job information.

13. The network of claim 1, wherein the enterprise server associates the scan data with passenger information for a corresponding passenger checking in the scanned item.

14. The network of claim 1, wherein the enterprise server includes a conferencing module for establishing a video conference between multiple remote terminals to permit operators of the multiple remote terminals to view simultaneously an individual, common scan image.

15. The network of claim 1, wherein the enterprise server includes a conferencing module for establishing an audio conference between multiple the remote terminals to permit operators of sad? multiple remote terminals to interact simultaneously regarding common scan data.

16. The network of claim 1, wherein the local terminal includes an instant-messaging module that, upon a command from a local operator, generates a review request that the enterprise server automatically routes from the local terminal to the remote terminal.

17. The network of claim 1, wherein the enterprise server includes an instant-messaging linking module for establishing a link between the remote terminal and the local terminal to permit operators of the local and remote terminals to interact with one another regarding common scan data.

18. The network of claim 1, wherein the enterprise server includes an expert-inquiry module that automatically conveys an alert to multiple the remote terminals when the scan data is identified to be a potential threat.

19. The network of claim 1, wherein the enterprise server includes an electronic unpacking module that, upon request from one of the local and remote terminal, removes portions of the scan image to expose interior items within the scan data.

20. The network of claim 1, further including memory storing the scan data for at least a length of time of a one-way or round-trip itinerary.

21. The network of claim 1, wherein the enterprise server performs computer aided detection of the scan data in connection with identifying potential objects of interest.

22. The network of claim 1, further comprising memory that records actions of an operator of one of local and remote terminal to form an action recording, the enterprise server replaying the action recording.
